(19) United States
(12) Patent Application Publication
(10) Pub. No.: US 2009/0077561 A1
(43) Pub. Date: Mar. 19, 2009

(54) Pipeline Processing Method and Apparatus in a Multi-processor Environment

(75) Inventors: Bo Feng, Beijing (CN); Ling Shao, Beijing (CN); Kai Zheng, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/167,657

(22) Filed: Jul. 3, 2008

(30) Foreign Application Priority Data
Jul. 5, 2007 (CN) 200712107457.9

(51) Int. Cl. G06F 9/50

(52) U.S. Cl. 718/104

(57) ABSTRACT

A pipelining processing method and apparatus in multi-processor environment partitions a task into overlapping sub-tasks that are to be allocated to multiple processors, overlapping portions among the respective sub-tasks being shared by the processors that process corresponding sub-tasks. A status of each of the processors is determined during a process where each of the processors executes sub-tasks and the overlapping portions among the respective sub-tasks to be executed by which processor among the processors is dynamically determined on the basis of the status of each of the processors.

### TECHNICAL FIELD

The present invention relates to a pipelining technology, in particular, to a pipeline processing method and apparatus in a multi-processor environment.

### BACKGROUND ART

DPI (Deep Packet Inspection), as a kind of emerging and popular-gaining network application, is performance sensitive. Its processing performance requirement proportionally relates to an interface wire-speed (since DPI deals with not only packet header but also packet payload).

Multi-processor (multi-core or multi-chip, e.g. SMP, Symmetrical Multi-processor) is a promising approach to addressing the DPI performance issue for its turbo processing/computing power. However, the traditional parallel programming model for data load-balancing cannot be adopted by DPI processing in certain cases. The reason is that network communications are usually based on flow/session (the so-called “flow” means the packet stream between an arbitrary source-destination communication pair), and the respective packets within a flow are highly related to each other and therefore should be processed in sequence to maintain data dependency. An unfortunate fact is that, due to the existence of such things as VPN tunnels, network flow might be very “huge” in size or may even dominate the whole cable bandwidth. The extreme case is that all packets are in a single tunnel flow and have to be processed in sequence, that is, cannot be well processed in parallel.

Pipelining technology is an alternative way to leverage the parallel processing resources to achieve performance gains, though it is not often seen in general purpose CPU platforms. Traditionally, the pipelining technology is used in hardware system and structure design. Recently, it was recognized as a programming model for network data in network processor techniques. Data packets, or the stream composed of data packets, are the processing objects of the DPI application. However, a DPI application itself is a program, which comprises a number of sub-programs or routines. Therefore, DPI application function per se can be partitioned by using pipelining technology, by which the programmer can partition a large task into small sub-tasks that are executed in sequence and allocate them to multiple processing units so as to make the multiple processing units work in parallel to achieve performance improvement. Compared with the parallel program model, the pipelining technology is a kind of “Task Load-Balancing” approach but not a “Data Load-Balancing” approach, and therefore retains data dependency.

On the other hand, it is noted that only when the loads of the sub-tasks are well balanced among the processors, can the computation resources be fully utilized to achieve optimal gain of the multi-core processor. However, traditional pipeline programs suffer from very low adaptive ability so that the tasks have to be pre-partitioned and statically allocated to specific processors. Note that the code path of each packet often differs from paths of the others, that is, a same DPI application may have differences for different packets, in particular sub-programs and computation resource requirements of each sub-program may be different, thus one can hardly expect that high resource utilization can be achieved by a static approach. This is essential in the case of DPI, since even one percent loss in performance gain may lead to mismatch with performance.

Similarly, in the case of many applications other than DPI applications, there also exists a problem of how to make sub-tasks balance among multiple processors, regardless of the kind of task and the data to be processed. The above discussion takes DPI as an example to show the problem posed in the prior art, since the problem of data load-balancing and task load-balancing for DPI is more pressing.

### SUMMARY OF INVENTION

Considering the above-mentioned problem, it is necessary to make loads of sub-tasks be better balanced among respective processors.

The present invention, therefore, provides a dynamic pipelining sub-task scheduling approach in a multi-processor environment. The main idea thereof is to share portions of the codes/routines among processors in the pipeline, and dynamically schedule the sub-tasks among processors based on their real-time load.

Further, the present invention further provides solutions with respect to the following problems:

1) how to share the codes/routines among the processors to achieve adaptive ability, while avoiding non-reasonable overhead; and

2) how to trigger a sub-task re-allocation activity with minimal overhead, and how to determine from where to make re-allocation.

Specifically speaking, the present invention provides a pipeline processing method in a multiprocessor environment, comprising: partitioning a task into overlapping sub-tasks that are to be allocated to multiple processors, wherein overlapping portions among the respective sub-tasks are shared by processors that process corresponding sub-tasks; determining a status of each of the processors during a process where each of the processors executes said sub-tasks; and dynamically determining the overlapping portions among the respective sub-tasks that are to be executed by which processors that process the corresponding sub-tasks, on the basis of the status of each of the processors.

The present invention further provides a pipeline processing apparatus in a multi-processor environment, comprising: partitioning means for partitioning a task into overlapping sub-tasks that are to be allocated to multiple processors, wherein overlapping portions among the respective sub-tasks are shared by processors that process corresponding sub-tasks; processor status determining means for determining a status of each of the processors during a process where each of the processors executes said sub-tasks; dynamic adjusting means for dynamically determining the overlapping portions among the respective sub-tasks that are to be executed by which of the processors that process the corresponding sub-tasks, on the basis of the status of each of the processors.

In one preferable embodiment of the present invention, workload of each of the processors can be determined on the basis of one of the following factors or a combination thereof: status of task queues of each of the processors; status of instruction queues of each of the processors; throughput of each of the processors; and processing delay of each of the processors. Alternatively, a processor status may be informed periodically and initiatively by each of the processors.

In another preferable embodiment of the present invention, partitioning of a task further includes the steps of: analyzing the task to get a call-graph of sub-functions of the task; determining a critical path for sub-functions of the task on the basis of the call-graph; and performing task partitioning on the basis of said critical path.

In yet another preferable embodiment of the present invention, performing task partitioning on the basis of said critical path may further include: analyzing a self-time and/or a code-length in each of the sub-functions in the critical path and performing task partitioning on the basis of an accumulated time and/or an accumulated code-length in each of the sub-functions in the task.

In another preferable embodiment of the present invention, at least one of the following factors shall be taken into consideration when executing task partitioning on the basis of said critical path: self-timing of each of the sub-functions; code-length of each of the sub-functions; ratio of code redundancy of the task; instruction/data locality; local store size; cache size; load stability of each of the sub-functions; and coupling degree among the sub-functions.

In a preferable embodiment of the present invention, determination of processor status and/or dynamic adjustment may be integrated into the task itself, or may be accomplished by monitoring the processor and/or task externally.

According to the above solutions of the present invention, dynamic-balancing of sub-tasks between multiple processors is achieved, thereby fully utilizing computation resources to achieve optimal gain of the multi-core processor.

### BRIEF DESCRIPTION OF THE DRAWINGS

The present invention will be described in detail in combination with accompanying drawings, wherein:

FIG. 1 illustrates a static partition of a task in the prior art;

FIG. 2 illustrates a dynamic task partition method of the present invention;

FIGS. 3-6 illustrate each of the steps in a pipeline processing method according to respective embodiments of the present invention.

FIG. 7 is a flowchart illustrating a pipeline processing method according to one embodiment of the present invention.

FIG. 8 is a flowchart illustrating in detail a task partition step in the pipeline processing method illustrated in FIG. 7.

FIG. 9 is a diagram illustrating sub-task dynamic adjustment according to one embodiment of the present invention.

FIG. 10 illustrates a block diagram of a pipeline processing apparatus according to one embodiment of the present invention.

### DETAILED DESCRIPTION OF THE INVENTION

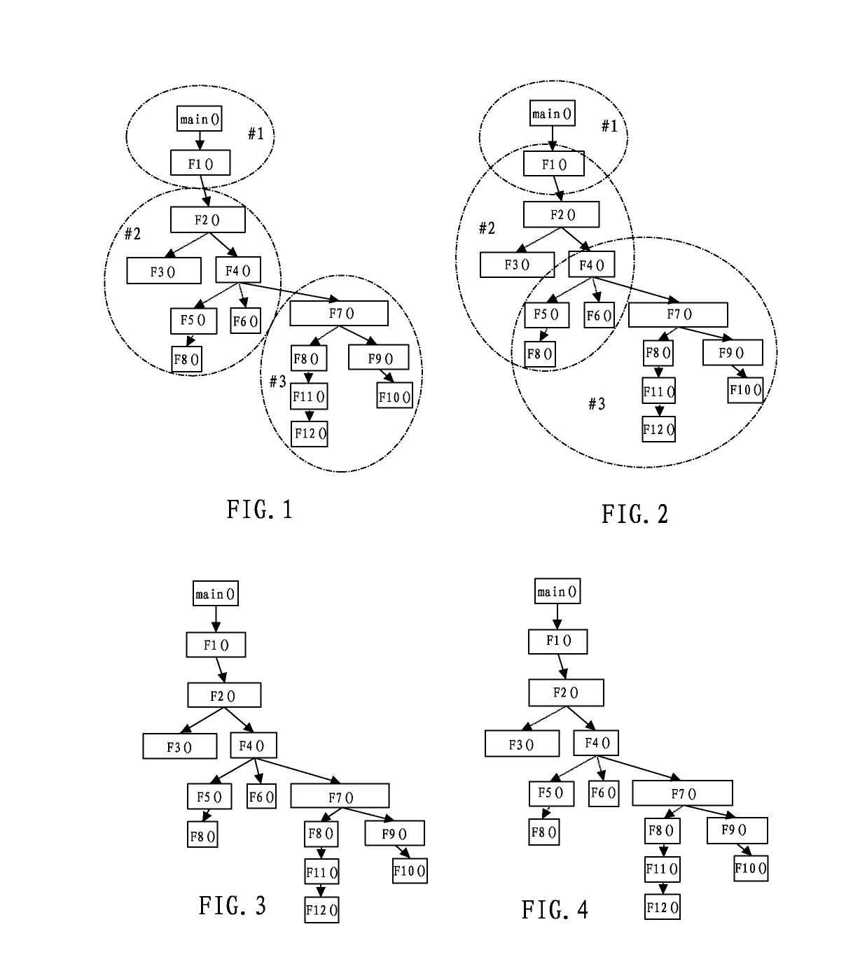

FIG. 1, as an example, is a call-graph of an application having eleven functions, routines main( ) and F1( ) to F10( ). A static partition is executed for the respective functions according to traditional pipeline processing techniques. For example, F1( ) is executed by processor #1, F2( ) to F6( ) and a further function call to F5( ) are executed by processor #2, F7( ) and function calls followed thereby are executed by processor #3. As recited in the background art, such static partitioning has a very low adaptive ability. Thus, in actual execution of an application, tasks of each of the processors may not be balanced as the processed data are different. For example, when F7( ) is not called by F4( ), processor #3 is idle for this application, while processor #2 needs to process more tasks than required when F7( ) is called by F4( ), that is, it needs to additionally process F5( ), F6( ), etc.

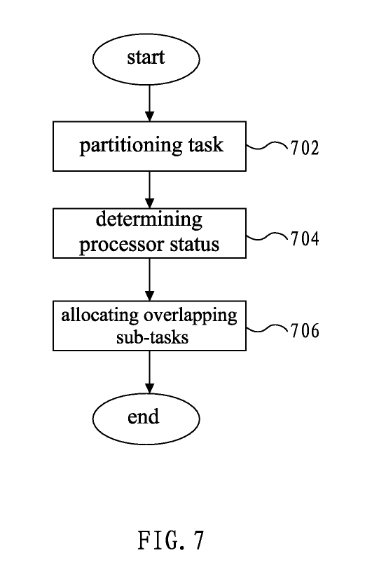

Therefore, regarding this problem, the present invention proposes a new pipeline processing method, making sub-tasks processed by the respective processors overlap to a certain extent when partitioning into sub-tasks and allocating these sub-tasks to each of the processors (i.e. overlapping sub-tasks are “shared” by the multiple processors) (Step 702, FIG. 7). A status of each of the processors is determined during a process of executing a task (Step 704, FIG. 7), on the basis of which, it is dynamically determined which overlapping portions are to be executed by which of the processors that share overlapping sub-tasks (Step 706, FIG. 7), hereinafter referred to as sub-task dynamic adjustment, thereby realizing a dynamic balance among multiple processors.

Taking still the application illustrated in FIG. 1 as an example, as illustrated in FIG. 2, according to the method of the present invention, F1( ) is shared by processors #1 and #2, and F4( ) as well as calls to F5( ) and F6( ) from F4( ) are shared by processors #2 and #3. In that case, if processor #2 is idler than processor #1 during the actual execution process, then F1( ) can be executed by processor #2; otherwise, F1( ) can be executed by processor #1. Likewise, if processor #3 is idler than processor #2 during the actual execution process, then F4( ) as well as calls to F5( ) and F6( ) from F4( ) can be executed by processor #3; otherwise, F4( ) as well as calls to F5( ) and F6( ) from F4( ) can be executed by processor #2. Thus, a dynamic balance among processors #1, #2, #3 is realized.

In the above example, overlapping portions of the sub-tasks are merely shared by two processors, such as, F1( ) is shared by processors #1 and #2, and F4( ) as well as calls to F5( ) and F6( ) from F4( ) are shared by processors #2 and #3. However, the present invention is not limited to this. If necessary, a same sub-task may be shared by more processors.

During actual runtime of an application, dynamic adjustment of sub-tasks can be accomplished by various methods. The key point is that every processor should, by any means, be aware of the real-time workload ratio of itself and its “neighbors”, and the shared portions of the sub-tasks are always delivered to the processors currently with relatively lower workload. One of the feasible methods is to inject instrumentation codes into the shared routines for dynamic adjustment. Injection of instrumentation codes is a typical means for analyzing a target program or optimizing a target program. Usually, instrumentation codes are injected into entries or exits of some functions. That is to say, after injection of instrumentation codes, the original program will initially execute the instrumented codes before execution/release.

In the present invention, instrumentation codes are injected into exits (or entries) of the shared routines, such codes are in charge of dynamically determining the shared sub-tasks that are to be executed by which processor on the basis of the “busy/idle” status of the processors. In principle, the processor that is currently least busy is to execute the shared sub-tasks. For example, such codes may be in charge of looking up the status of the Task Queues (TQ) of related processors (including those of the processor running the current code) and determining whether to take or not the following shared task(s) on the basis of load-balancing principles. If so, continue to work on the shared task(s) or if not, transit such portion of the shared task(s) to a processor following in the pipeline, and meanwhile prepare a desired context (such as source data and half-done data) for the processor to process the current data (such as, packet in terms of DPI, e.g. IP packet). If there are additional data (such as, next packet in terms of DPI) to be processed, then the associated processor itself shifts back to process the additional data (i.e., the next packet).

Next, an example of injection of instrumentation codes represented by pseudo-code is illustrated. Still, taking FIG. 2 as an example, it is assumed that F2( ) is allocated to processor #2. Instrumentation code is injected into the end of F2( ), and then whether F4( ) called in F2( ) is processed by processor #2 or processor #3 is judged on the basis of the length of the waiting queue of processors #2 and #3.

F2( )//assumed that F2( ) is allocated to processor #2

{
...
//the following are instrumentation code injected at the

exit of F2( )

| | |
|---|---|
| if | (_Length_of_TQ(Processor |

#2)<_Length_of_TQ(Processor #3))//

comparing the length of Tasks Queues of the two processors
{F4( );

preparing data (1) for next processor; // parameter

“1” represents that the shared tasks need to be accomplished
simultaneously;

};

else

preparing data (o) for next processor; // parameter

“0” represents that the shared tasks are to be executed by
the next processor, and the current processor merely needs
to prepare data

return;
}

API (such as function “Length_of_TQ ( )” in the above pseudo-code) that provides length of Task Queues of the processors can be easily provided by the OS/Runtime or hardware drivers.

As recited above, a dynamic adjustment of sub-tasks can be accomplished by various methods. A method of such as daemon process can serve as another example in addition to injection of instrumentation codes.

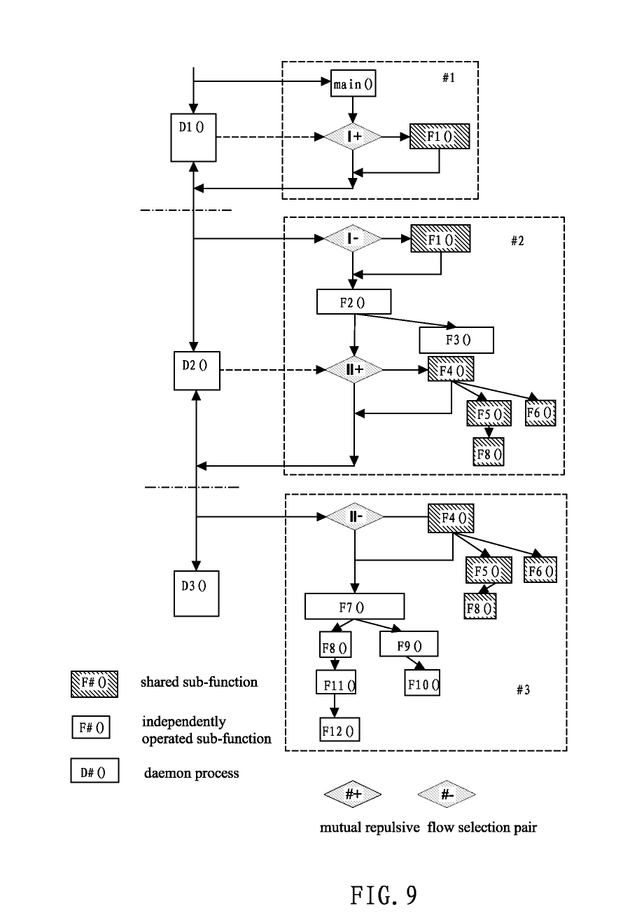

As shown in FIG. 9, it is assumed that the partitioning of a task is still as that illustrated in FIGS. 2 and 6, that is, sub-function F1( ) is shared by processors #1 and #2, and sub-function F4( ) (together with all its sideways sub-functions F5( ), F6( ), and F8( )) is shared by processors #2 and #3. The principle of the daemon process is as follows:

1) a “daemon process” is additionally set for each of the processors, that is, D1( ), D2( ), and D3( ) in FIG. 9;

2) the daemon processes permanently reside in corresponding processors #1, #2, #3, and are in charge of monitoring the status of the corresponding processor. They also dynamically control a “pair of mutual repulsive flow selection switches” respectively located in two adjacent processors on the basis of the current loading state of the processors so that one of the two processors (such as the one with lower load) processes the shared sub-functions while the other bypasses the shared sub-functions, thereby to achieve a dynamic adjustment.

When adopting the method of the daemon process, it is unnecessary to inject specific instrumentation codes into specific running codes. What is needed is to provide an indication “capable of dynamically adjusting sub-functions” and a controllable function switch on the basis of the interface of the daemon process.

In addition, a communication interface is needed between daemon processes, such as between daemon processes respectively corresponding to an up level and a down level of a pipeline (e.g. between D1( ) and D2( ) in FIG. 9), which is used for exchanging information on data flow orientation among daemon processors and for communicating a decision-making of the dynamic adjustment to a downstream daemon processor so as to avoiding leakage or repetition of a task.

Specifically speaking, for example, as illustrated in FIG. 9, daemon processors D1( ), D2( ), and D3( ) monitor the execution of each of the sub-tasks as well as the status of each of the processors and communicate with each other, thereby to determine the shared portions of the sub-tasks to be executed by each processor. For example, if D1( ) determines that F1( ) is executed by processor #2, then D1( ) gives an instruction that F1( ) is not executed by processor #1 and notifies D2( ) of this information and related half-way data. Then, D2( ) gives an instruction that F1( ) is executed by processor #2, and so on.

It can be noted that, in the aforementioned description of the instrumentation, the lengths of task queues of the processors are used with respect to the status of each of the processors, which merely serves as an example. Actually, in the prior art, various methods may be adopted to determine the status of processors, for example, hardware of the processor (CPU) may be modified to be capable of providing its own status or a more complex dynamic task prediction method may be adopted. Alternatively, for example, in Windows or Linux/Unix operation systems, there is a tool for monitoring CPU load. The above-discussed example of task queues is a processing manner in terms of a user application in OS, which can reflect a relationship between the CPU load and the task requirements in terms of task, thereby to determine whether the CPU is busy or idle. In addition, CPU instruction queues may also be monitored. The current CPU works in a pipeline manner, wherein the beginning of the pipeline has an instruction queue for storing instructions obtained from the OS to be executed and the queue being relatively small. If the instruction queue is fully occupied or very long for a long time, it indicates that the CPU is heavily loaded and cannot keep pace with the processing requirements; otherwise, if this queue is empty or very short, it indicates that the load is light.

Other than the above CPU instruction queue reading method (micro granularity) and system-level corresponding CPU task queue status reading method (macro granularity), a lot of methods can be adopted to determine the status of processors. For example, a configurable timer and reporting module may be arranged in the CPU, for initiatively providing the status of this CPU or CPU core for the system, taking a specified period of time or the number of running instruction as a cycle. Compared with the above two methods, this method initiatively reports the status to the system, instead of passively answering a query for status from the system, which thus can save system overhead to some extent. The difference between the effects created by this method and by the above two methods is similar to the difference between poll and interruption.

Regarding the determination of the status of the CPU, in addition to the above-mentioned very precise in-real query, the status also can be obtained by statistically counting the throughput and/or processing delay of the CPU. Specifically, whether or not a CPU is fully utilized can be known from statistical data about the tasks allocated to the CPU and the completion status thereof. On principle, a CPU that responds slowly to the task allocated thereto is considered to run under heavy load; contrarily, a CPU that can finish a majority of the tasks with a small processing delay is considered to be idle. As for the specific operation, a system time is recorded when a task is delivered to the CPU, and then a processing delay can be calculated on the basis of the difference between the current time and the time when the task is finished. Therefore, the status of each of the CPUs being either idle or busy can be determined by comparing the processing delay of each of the CPUs.

The above-discussed step of partitioning into sub-tasks and allocating these sub-tasks to each of the processors (Step 702, FIG. 7) can be executed by using the task partitioning method of the prior art. However, according to the present invention, the tasks to be allocated to each of the processors are made to have overlapping portions that can be dynamically allocated during execution, by moving the start point and end point of each portion of the sub-tasks in the traditional task partitioning method.

Task partitioning is usually performed with respect to a critical path, which thus needs to be based on recognition of the critical path. A critical path generally means a call link with the most time-consumption in a function call-graph of a program. Referring to FIG. 4, real-line blocks and arrows represent the critical path, wherein main ( )->F1( )->F2( ) are in a one-to-one call relation, which naturally are included in the critical path, while, F3( ) or F4( ) may be called by F2( ), if it is assumed that the total runtime of F4( ) during the runtime period (which generally equals a product of the number of times of the calls and runtime for a single call) is larger than F3( ), then F2( )->F4( ) belongs to a part of the critical path but F2( )->F3( ) does not belong to a part of the critical path, and so on. As an example, the critical path as illustrated in FIG. 4 is: main( )->F1( )->F2( )->F4( )->F7( ) (F9( )->F10( ), which is the so-called critical path. Of course, it may be considered that other standards can be employed to determine a critical path, such as taking code-length (which will be described in detail hereinafter) as a standard. After the determination of critical path, task partitioning can be performed as illustrated in FIG. 1 or 2 by using the traditional method.

For a certain application, a critical path may be known, for example, information on critical path may have been stored during programming, or the critical path may have been analyzed before, or the critical path may be provided by an external tool.

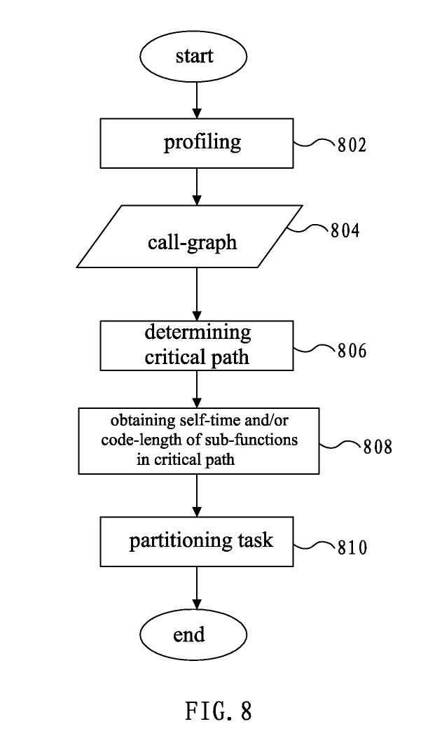

For an application with unknown critical path, firstly, it is necessary to profile the application (Step 802, FIG. 8) to get the call-graph of the application (Step 804, FIG. 8), which step can be achieved by many existing tools, such as, by using application/code analyzing tools like Intel vTune (which is available on the internet at the address intel.com/cd/software/products/apac/zho/vtune/index.htm), or GNU gprof (at address gnu.org/software/binutils/manual/gprof-2.9.1/gprof.html) or oprofile (at address oprofile.sourceforge.net/news/). FIG. 3 is a call-graph of the application illustrated in FIGS. 1 and 2. In most applications, in particular in a DPI application (as a kind of stream processing), forward function calls are seldom seen. In other words, the call-graph tends to look like a “tree” rather than a “graph”. This would be helpful for sub-tasking. For example, the tree illustrated in FIG. 3 is actually a graph, since F8( ) is called both under F5( ) and F7( ); however, for the convenience of task partitioning and this description, FIG. 3 may be denoted in a tree-like form.

Then, the critical path for data processing is determined on the basis of the call-graph (Step 806, FIG. 8). After finding out the critical path, task partitioning can be performed as illustrated in FIG. 1 or 2 by using the traditional method.

In one preferable embodiment of the present invention, in order to make the loads of processors well balanced, a more preferable embodiment concerning task partitioning is proposed, so as to more accurately and evenly partition the tasks and to more appropriately determine the shared sub-tasks among the processors.

Thus, a further analysis is necessary to find out the “self-time” in each function in the critical path (Step 808, FIG. 8).

Herein, the “self-time” means the time cost by a specific function itself, including time cost by the critical path in all its sideways sub-functions. For example, in FIG. 4, in terms of F4( ), the “self-time” thereof does not include its time cost by the sub-function F7( ) in its critical path. The sub-functions called by F4( ) but not in the critical path are sideways sub-functions, such as F5( ) (which further calls F8( )) and F6( ). If F4( ) is considered as a main function, similar to the above discussion, there also exists a critical path. Here, it is assumed that the time of F5( )->F8( ) is longer than F6( ), then the critical path of the sideways sub-functions of F4( ) is F5( )->F8( ). That is to say, in the example illustrated in FIG. 4, the self-time of F4( ) is the time cost by F4( ) itself together with the time cost by the critical path F5( )->F8( ) in its sideways sub-functions. For example, as for F2( ) or F7( ), since the sub-functions called thereby have only one call link besides that in the critical path, this call link is the critical path of the sideways sub-functions. In the prior art, there also are a lot of tools capable of analyzing to find out the self-time of functions, such as the above-mentioned profiling tool.

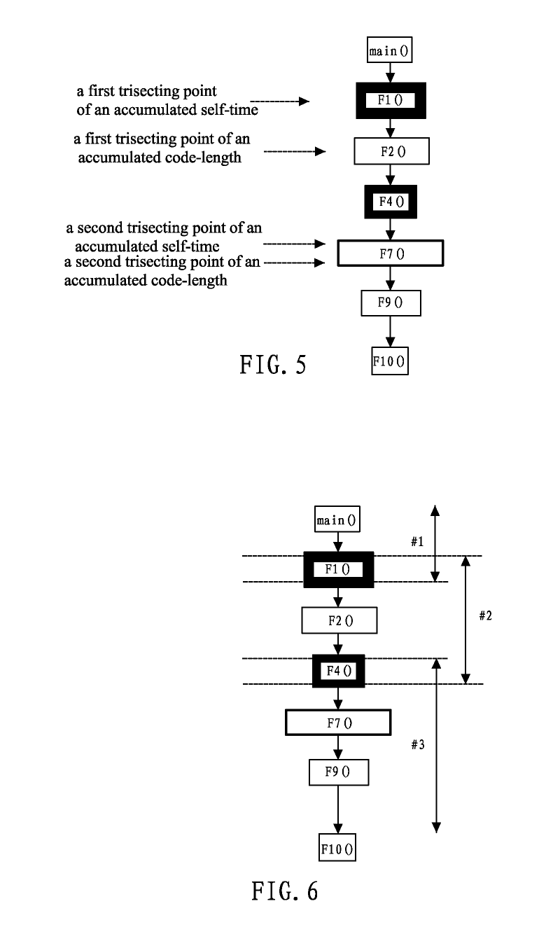

According to one embodiment, once the self-time has been obtained, a task can be partitioned on the basis of time average principles and the routines at critical points are shared by two adjacent processors (Step 808, FIG. 8). For example, as illustrated in FIG. 5, the width of the boxes that represent each of the functions diagrammatically indicates the self-time. It is assumed, as in FIGS. 1 and 2, that there are three processors #1, #2 and #3, and the critical path is substantially trisected into three segments on the basis of the accumulated self-time (since the accumulated self-time is calculated in a unit of function, which thus generally cannot be absolutely equally partitioned). It may be assumed that the trisecting points of the self-time are located at F1( ) and F7( ), then task partitioning can be performed in these two functions, and these two functions F1( ) and F7( ) (including their sideways sub-functions) are shared by adjacent processors in the corresponding pipeline.

As an alternative solution to “self-time”, “code-length” may also be employed to perform task partitioning. Thus, it is necessary to determine the code-length in each function in the critical path (Step 808, FIG. 8). Code-length means the number of lines of instruction codes in a function, or may be understood as an amount of CPU compiling instructions necessary for executing a segment of a program. As with self-time, code-length of a function also includes code-length in the critical path in its sideways sub-functions. Code-length can be easily obtained by a disassembly tool, such as the aforementioned Intel vTune. After obtaining the code-length, a task can be partitioned on the basis of code-length average principles and the routines at critical points are shared by two adjacent processors (Step 808, FIG. 8). For example, as illustrated in FIG. 5, the transverse width of the boxes that represent each of the functions diagrammatically denotes the code-length. It is assumed, as that in FIGS. 1 and 2, there are three processors #1, #2 and #3, and the critical path is substantially trisected into three segments on the basis of the accumulated code-length (since the accumulated code-length is calculated in a unit of function, which thus generally cannot be absolutely equally partitioned). It may be assumed that, the trisecting points of the code-length are located at F2( ) and F7( ), then task partitioning can be performed in these two functions, and these two functions F2( ) and F7( ) (including their sideways sub-functions) are shared by adjacent processors in the corresponding pipeline.

According to a preferable embodiment, the self-time and code-length can be simultaneously determined in Step 8, thereby to perform task partitioning by comprehensively taking both self-time and code-length into consideration (Step 810, FIG. 8). Still taking FIG. 5 as an example, the critical path is substantially trisected into three segments respectively on the basis of self-time and code-length. It may be still assumed that the trisecting points of the self-time are located at F1( ) and F7( ) and the trisecting points of the code-length are located at F2( ) and F7( ), then task partitioning can be performed by reference to these two kinds of trisecting points. By example, it may be considered to make functions between the equally partitioned points, corresponding to the above two equal partition manners, be shared by corresponding adjacent processors. In FIG. 5, F2( ) and F7( ) (including their sideways sub-functions) are shared by adjacent processors in the corresponding pipeline.

According to a more preferable embodiment of the present invention, when performing task partitioning on the basis of the above self-time and code-length equally partitioned points, some heuristic rules (or “constraints”) may be applied, wherein such rules include but are not limited to the following:

1. Routines with large code-length but short self-time should preferably not be shared among the processors (e.g., F7( ) in the example), but otherwise better be shared (e.g. F1( ) in the example). According to this rule, with respect to the examples in FIG. 5, for example, task partitioning may be performed as illustrated in FIG. 6, that is, F1( ) and F4( ) with relatively short code-length but relatively long self-time in neighborhood of the two kinds of equally partitioned points are shared among the processors. It is noted that, the size of the code-length and self-time described herein is not an absolute value but a value relative to each of the functions, which should be prescribed on the basis of particular application and user's actual requirements and experiences. In a particular application, if a program is used to automatically partition a task, then, of course, a quantized value can be given. This can be obtained by those skilled in the art by paying out conventional efforts.

2. The adaptive ability of task-balancing and requirements of the instruction/data locality to the code redundancy can be evenly taken into consideration, thereby to select a proper ratio of code redundancy. A ratio of code redundancy is a ratio of the redundant code to the total code, for example, as for a program of 1,000 lines (profiling codes), if the shared sub-programs between processors #1 and #2 have 100 lines and the shared sub-programs between processors #2 and #3 have 200 lines, the ratio of code redundancy is: (100+200)/1000=30%. Sharing more codes may provide better adaptive ability. For example, although only one sub-function (together with its sideways sub-functions) is shared among the processors in the examples illustrated in FIGS. 2 and 6, it is completely possible to share many more sub-functions among the processors. However, the higher the ratio of code redundancy, the worse the instruction/data locality will be. Therefore, in terms of a particular application, it is necessary to evenly take both the adaptive ability of task-balancing and requirements of a ratio of the instruction/data locality to the code redundancy into consideration.

3. The local store/cache size can be taken into consideration for selecting a proper ratio of code redundancy. If excessive codes are shared among the processors, extra cache misses or insufficient memory problems will occur, which thus may result in other performance problems.

4. In the view of improving store access locality, some sub-functions may be prescribed as not suitable for being shared among the processors, for example when data or instruction space accessed by the sub-programs is very regular or fixed. If these sub-programs are allowed to be re-scheduled among multiple processors, the locality will be significantly deteriorated.

5. It may be prescribed that a task processed by a certain processor not be shared by other processors, for example when a processor runs a sub-program with a stable load and the computation resources of the processor can be substantially fully utilized. If a portion of sub-programs is shared by other processors, the utilization percentage of this processor may shake, thereby reducing the utilization percentage.

6. Points that are more proper to be as a partitioning point according to any standards can be found out in the function call link, thereby to assist the above task partitioning. For example, at such call points, communication between the calling side and the called side are less and there are fewer demands for real-time ability, that is, it has a so-called weak coupling.

Obviously, the above heuristic rules merely serve as examples. There are much more heuristic rules in actual applications.

The above has described a pipeline processing method in a multi-processor environment according to the present invention. Next, a pipeline processing apparatus in a multi-processor environment according to the present invention will be described. In the following description, for the sake of simplicity, parts which are the same as or similar to those in the aforementioned pipeline processing method will not be repeatedly described, and technical details described with respect to the pipeline processing method are applicable to the pipeline processing apparatus. In addition, technical details described with respect to the pipeline processing apparatus are applicable to the pipeline processing method.

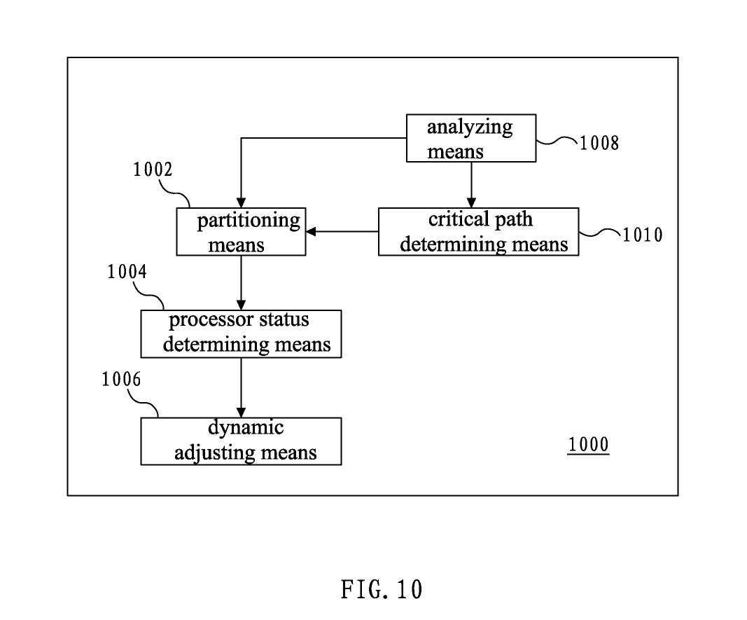

FIG. 10 illustrates a pipeline processing apparatus 1000 according to one preferable embodiment of the present invention.

The pipeline processing apparatus 1000 comprises partitioning means 1002, processor status determining means 1004, and dynamic adjusting means 1006. The partitioning means 1002, when partitioning a task into sub-tasks and allocating these sub-tasks to each of the processors, causes the sub-tasks processed by each of the processors to be overlapped to a certain extent; that is, the overlapping portions of the sub-tasks are shared by the multiple processors. A status of each of the processors is determined by the processor status determining means 1004 during a process of executing task(s), on the basis of which a dynamic determination is made as to which overlapping portions are to be executed by which of the processors that share overlapping sub-tasks (hereinafter referred to as sub-task dynamic adjustment), thereby realizing a dynamic balance among multiple processors.

Detailed examples concerning how the partitioning means 1002 performs task partitioning and how the dynamic adjusting means 1006 performs sub-task dynamic adjustment may be obtained by reference to the above description in combination with FIG. 2.

As above, the determination of the status of processors can be achieved by many ways, comprising (but not limited to): instruction queue reading method (micro granularity) and system-level corresponding CPU task queue status reading method (macro granularity), arranging a configurable timer and reporting module in the CPU for initiatively providing the status of this CPU or CPU core, or statistically counting the throughput and/or processing delay of the CPU, etc. In addition, there are a lot of existing tools capable of monitoring the CPU load. For example, whether in Windows or Linux/Unix operation systems, tools are included for monitoring CPU load.

As above, the determination of the status of the processors and the dynamic adjustment of the sub-tasks can be accomplished by a manner of injecting instrumentation code into an application that serves as a task. That is to say, the processor status determining means 1004 and the dynamic adjusting means 1006 can be integrated into a task itself.

In one preferable embodiment, in terms of the processor status determining means 1004, its task is relatively independent, which thus can be realized separately as a module outside the task, wherein the module includes the existing modules (such as the above-mentioned tools for monitoring CPU load in operating systems), while the dynamic adjusting means 1006 merely needs to read processor status directly from the outside processor status determining means 1004.

In one preferable embodiment, without the injection of instrumentation codes, the dynamic adjusting means 1006 can be realized outside the task, for example, by means of the aforementioned daemon process. Herein, similar to the above preferable embodiment, the processor status determining means 1004 not only can be realized together with the dynamic adjusting means 1006 by a daemon process, but also can be realized as a separate means outside the daemon process, while the dynamic adjusting means 1006 merely needs to read processor status directly from the processor status determining means 1004.

The partitioning means 1002 can be realized by using the prior art. However, according to the present invention, it is necessary to make the tasks to be allocated to each of the processors have overlapping portions that can be dynamically allocated during execution, moving the start point and end point of each portion of the sub-tasks in the related art.

As recited above, task partitioning by the partitioning means 1002 is usually performed with respect to the critical path, which thus has to be based on the recognition of the critical path. On the basis of the critical path, task partitioning as illustrated in FIG. 1 or 2 can be performed by using the traditional method.

For a certain application, a critical path may be known, for example, information on critical path may have been stored during programming, or the critical path may have been analyzed before, or the critical path may be provided by an external tool.

When a critical path is unknown and it is necessary to analyze so as to obtain the critical path, firstly, an analyzing means 1008 needs to profile the application to get the call-graph of the application, which step can be accomplished by many existing tools, such as, by using application/code analyzing tools like Intel vTune or GNU gprof or oprofile, or by using principles similar to the above tools.

Then, the critical path for data processing is determined by critical path determining means 1010 on the basis of the call-graph. Many existing tools are available for the determination of critical path. For example, the abovementioned profiling tool can also be used to determine critical path.

In this way, based on the determined critical path, the partitioning means 1002 can perform task partitioning. In the present invention, in order to make the loads of processors well balanced, a more preferable embodiment concerning task partitioning is proposed, so as to more accurately and evenly partition the tasks and to more appropriately determine the shared sub-tasks among the processors.

Thus, the analyzing means 1008 may be configured to find out the “self-time” in each function in the critical path, and the partitioning means 1002 is configured to perform task partitioning on the basis of time average principles and make the routines at the critical points be shared by two adjacent processors. In the prior art, there are a lot of tools capable of obtaining the self-time of a function by analysis, such as the aforementioned profiling tools.

As a substitutive solution of “self-time”, “code-length” may also be employed to perform task partitioning. Thus, the analyzing means 1008 may be configured to find out the code-length in each function in the critical path and the partitioning means 1002 is configured to perform task partitioning on the basis of code-length average principles and to make the routines at the critical points be shared by two adjacent processors. In the prior art, there are a lot of tools capable of obtaining the code-length of a function by analysis, such as the aforementioned profiling tools.

According to one preferable embodiment, the analyzing means 1008 may be configured to simultaneously determine the self-time and the code-length in each function in the critical path and the partitioning means 1002 is configured to comprehensively take both the self-time and the code-length into consideration so as to perform task partitioning.

According to a more preferable embodiment, some heuristic rules (or say constraints) may be applied to the partitioning means 1002, wherein such rules include but are not limited to the following:

1. Routines with large code-length but short self-time should not be shared, otherwise better be shared.

2. The adaptive ability of task-balancing and requirements of the instruction/data locality to the code redundancy can be evenly taken into consideration, thereby to select a proper ratio of code redundancy.

3. The local store/cache size can be taken into consideration for selecting a proper ratio of code redundancy.

4. In the view of improving store access locality, some sub-functions may be prescribed as not suitable for sharing among the processors.

5. It may be prescribed that a task processed by a certain processor not be shared by other processors.

6. Points that are more proper to be partitioned according to various standards can be found out in the function call link, thereby to assist the above task partitioning.

Obviously, the above-mentioned heuristic rules are only an example. In actual application, there may be other heuristic rules.

As appreciated by those skilled in the art, all or any steps or component of the method and apparatus of the present invention can be realized in any computer devices (including processor, storage medium, etc.) or a network of computer devices, in a form of hardware, firmware or software or the combination thereof. This can be realized by those skilled in the art utilizing the basic programming skills grasped thereby on the basis of fully understanding of the content disclosed in the present invention, therefore, it is unnecessary to describe it in detail herein.

In addition, it is apparent that, when possible external operations are involved in the above description, undoubtedly, it is necessary to use display devices and input devices, corresponding interfaces and control programs connected to computer devices. A computer, a computer system, or related hardware and software in a computer network, as well as hardware, firmware or software or the combination thereof for realizing various operations in the above method of the present invention, constitute the apparatus and its components of the present invention.

Thus, based on the above appreciation, the purpose of the present invention also can be realized by running a program or a set of programs on any information processing device, wherein the information processing device can be a known general purpose device. Therefore, the purpose of the present invention can also be realized by only providing a program product containing program codes for realizing the method and apparatus. That is to say, such program product also constitutes the present invention, and a storage medium storing such program product also constitutes the present invention. Obviously, said storage medium can be a known one to those skilled in the art, or a storage medium of any type that would be developed in the future, thus it is unnecessary to list such storage medium one by one.

In the method and apparatus of the present invention, each of the steps or components can be disassembled and/or re-combined. Such disassemble or re-combination shall be taken as equivalent solution to the present invention.

It can be known from the above description that, the present invention adopts a pipeline model to partition a task and has an ability of dynamically re-allocating portions of sub-tasks, thereby adaptively to balance load among the processors associated with the sub-tasks. This allows the processing resources to be better utilized. In addition, since the code-path is shortened (due to the fact that a large task is partitioned into small ones), better instruction locality is achieved. This is important for a processor with small cache (e.g., a small L2 cache and without a L3 cache) or small local storage (e.g. IBM CELL processor). When applying the present invention to network data processing (such as DPI), a pipeline model is adopted so as to retain the sequence of packet processing and therefore avoid the data dependency issue, while optimally utilize parallel resources and greatly enhancing the efficiency.

The present invention has been described in detail in combination with the preferable embodiments in the present invention as above. Those skilled in the art appreciate that, the present invention is not limited to the details described and illustrated herein, but comprises various improvements and modifications incorporated within the scope of the present invention, without departing from the scope and spirit of the present invention.

Particularly, it is obvious to those skilled in the art that, the present invention is not only applicable to DPI application, but also applicable to balance sub-tasks of any task among multiple processors, regardless what the task is and what data is to be processed.

What claimed is:

1. A pipeline processing method in a multiprocessor environment, comprising:
partitioning a task into overlapping sub-tasks that are to be allocated to multiple processors, wherein overlapping portions among respective sub-tasks are shared by processors that process corresponding sub-tasks;
determining a status of each of the processors during a process where each of the processors executes said sub-tasks; and
dynamically determining overlapping portions among the respective sub-tasks to be executed by which one of the processors that process the corresponding sub-tasks, on the basis of the status of each of the processors.

2. The pipeline processing method according to claim 1, wherein, the step of determining the status of each of the processors includes determining workload of each of the processors on the basis of one or more of the following factors:
status of task queues of each of the processors;
status of instruction queues of each of the processors;
throughput of each of the processors; and
processing delay of each of the processors.

3. The pipeline processing method according to claim 1, wherein, the step of determining the status of each of the processors includes determining workload of each of the processors on the basis of a processor status informed periodically and initiatively by each of the processors.

4. The pipeline processing method according to claim 1, wherein, the step of partitioning the task into overlapping sub-tasks that are to be allocated to multiple processors further includes:
analyzing a task to get a call-graph of sub-functions of the task;
determining a critical path for sub-functions of the task on the basis of the call-graph;
performing task partitioning on the basis of said critical path.

5. The pipeline processing method according to claim 4, wherein, the step of performing task partition on the basis of said critical path further includes:
analyzing a self-time and/or a code-length in each of the sub-functions in the critical path;
performing task partitioning on the basis of an accumulated self-time and/or an accumulated code-length in each of the sub-functions in the task.

6. The pipeline processing method according to claim 4 wherein the step of performing task partitioning on the basis of said critical path further at least takes at least one of the following factors into consideration:
self-time of each of the sub-functions;
code-length of each of the sub-functions;
ratio of code redundancy of the task;
instruction/data locality;
local store size;
cache size;
load stability of each of the sub-functions; and
coupling degree among the sub-functions.

7. The pipeline processing method according to claim 1, wherein, in the step of dynamically determining overlapping portions among the respective sub-tasks to be executed by which of the processors that process the corresponding sub-tasks on the basis of the status of each of the processors, the overlapping portions among the respective sub-tasks are allocated to an idler processor.

8. A pipeline processing apparatus in a multi-processor environment, comprising:
partitioning means for partitioning a task into overlapping sub-tasks that are to be allocated to multiple processors, wherein overlapping portions among respective sub-tasks are shared by processors that process corresponding sub-tasks;
processor status determining means for determining a status of each of the processors during a process where each of the processors executes said sub-tasks;
dynamic adjusting means for dynamically determining the overlapping portions among the respective sub-tasks to be executed by which ones of the processors that process the corresponding sub-tasks, on the basis of the status of each of the processors.

9. The pipeline processing apparatus according to claim 8, wherein, the processor status determining means is configured to determine workload of each of the processors on the basis of one of the following factors or a combination thereof:
status of task queues of each of the processors;
status of instruction queues of each of the processors;
throughput of each of the processors; and
processing delay of each of the processors.

10. The pipeline processing apparatus according to claim 8, wherein, the processor status determining means is configured to determine the status of each of the processors includes determining workload of each of the processors on the basis of a processor status informed periodically and initiatively by each of the processors.

11. The pipeline processing apparatus according to claim 8, further comprising:
analyzing means for analyzing the task to get a call-graph of sub-functions of the task;
critical path determining means for determining a critical path for sub-functions of the task on the basis of the call-graph;
wherein, said partitioning means performs task partitioning on the basis of said critical path.

12. The pipeline processing apparatus according to claim 11, wherein, the analyzing means is further configured to analyze a self-time and/or a code-length in each of the sub-functions in the critical path, and the partitioning means is configured to perform task partitioning on the basis of an accumulated self-time and/or an accumulated code-length in each of the sub-functions in the task.

13. The pipeline processing apparatus according to claim 11, wherein the partitioning means is configured to further at least take at least one of the following factors into consideration when performing task partitioning:
self-time of each of the sub-functions;
code-length of each of the sub-functions;
ratio of code redundancy of the task;
instruction/data locality;
local store size;
cache size;
load stability of each of the sub-functions; and
coupling degree among the sub-functions.

14. The pipeline processing apparatus according to claim 8, wherein, the processor status determining means and/or the dynamic adjusting means are integrated into the task itself.

15. The pipeline processing apparatus according to claim 8, wherein, the dynamic adjusting means allocates the overlapping portions among the respective sub-tasks to an idler processor.
